(19) United States
(12) Patent Application Publication
(10) Pub. No.: US 2008/0149536 A1
(43) Pub. Date: Jun. 26, 2008

(54) Method of Floating and Flotation Circuit

(75) Inventors: Seppo Ronkainen, Kauniainen (FI); Peter Bourke, Perth (AU)

Correspondence Address: SMITH-HILL AND BEDELL, P.C., 16100 NW CORNELL ROAD, SUITE 220, BEAVERTON, OR, 97006, US

(73) Assignee: OUTOTEC OYJ, Espoo (FI)

(21) Appl. No.: 11/816,898

(22) PCT Filed: Mar. 6, 2006
(86) PCT No.: PCT/FI06/00074

§ 371 Date: Aug. 22, 2007

(30) Foreign Application Priority Data
Mar. 7, 2005 (FI) 20050239

(51) Int. Cl. B03B 9/00; B03D 1/14

(52) U.S. Cl. 209/163; 209/162

(57) ABSTRACT

The invention is a flotation circuit for separating concentrates from slurry comprising grinded ore or oil sand. The slurry is floated in a flotation circuit that comprises flotation cells arranged is series or in parallel, and the slurry is divided at least into two fractions in a flotation cell system that is arranged to receive a feed of mineral slurry from a grinding circuit and provided with at least two outlet openings for discharging tailings with different particle size distributions. The flotation circuit also comprises cell lines, i.e. banks of cells, that are arranged to receive the tailings from the outlet openings of the receiving cell and adapted to process slurries with different particle size distribution.

### BACKGROUND OF THE INVENTION

This invention relates in general to flotation devices and flotation methods used in mineral separation. More specifically, the present invention relates to a method of and an apparatus for flotation of slurry that contains mineral particles or oil sands.

At flotation plants, it is common practice to arrange several flotation cells in line to achieve desired efficiency in the recovery of valuable ingredients. A conventional flotation cell includes a tank for receiving and containing slurry from a grinding circuit, a flotation mechanism comprising a rotor and a stator disposed within the tank, and an aeration system for direct dispersing gas into the flotation mechanism. The gas bubbles dispersed in the slurry rise toward the surface of the slurry and carry with them floatable, hydrophobic particles which form a froth layer on the surface of the slurry. The froth is withdrawn from the cell via a froth launder system. Gangue particles and particles not recovered by flotation are discharged from the cell through a bottom outlet and led to succeeding flotation cell or elsewhere for further processing. The bottom outlet control is often provided with a dart or pinch valve, which is opened to allow the remaining slurry to progress under gravity feed to downstream treatment process, and allow the froth-slurry interface to be kept at even non-fluctuating condition.

Suitable flotation reagents are added to the feed of a flotation cell to improve the desired properties of valuable and gangue particles in the slurry. The reagents for instance cover the surfaces of the particles within the slurry to make the particles hydrophobic and thereby to promote bubble to particle attachment. The slurry contains both relatively coarse particles and relatively fine particles. The fine particles have a total surface area much greater than that of the coarse particles. Accordingly, when flotation reagents are added to the slurry, majority of it tends to be absorbed by the fine particles portion from the distribution of particles. Consequently, the coarse valuable particles do not receive sufficient amount of flotation reagents to reach adequate hydrophobicity. It is a well-known fact that flotation process can be made more efficient where coarse and fine particles are treated separately. Classifying devices, such as hydrocyclones and spiral separators have been used to separate a flotation feed stream into two discrete streams for separate processing. However, the equipment of the prior art methods is often uneconomical due to a very high capital investment, operating costs as well as maintenance downtime, loss in production.

### SUMMARY OF THE INVENTION

The object of this invention is to provide a flotation circuit for recovering valuable ingredients from mineral slurry efficiently and with low capital and operating costs. Another object of this invention is to produce an improved method of floating slurry with wide range of particles size.

In mineral processing, a conventional flotation circuit comprises one or several banks of flotation cells. One bank of cells is formed of cells arranged in series. Cell arrangements are established either in series or in parallel flow. The banks of cells are arranged in parallel when flows are too large for a single series line.

Now a novel type of flotation circuit for separating concentrates from mineral or oil sand slurry is introduced, where the flotation circuit comprises a flotation cell lines arranged in series or in parallel and a flotation cell system is arranged to receive a feed of mineral containing slurry from a grinding circuit with a flotation cell that is capable of classifying the slurry and that is provided with at least two outlet openings for discharging tailings with different particle size distributions and means of particle sizes. Adjacent to said flotation cell system, at least two parallel flotation cell lines are arranged to receive a flow of tailings from the output opening of the flotation cell system and adapted to process slurries with certain particle size distributions.

Also the present invention is a novel method of floating mineral slurry produced in a grinding circuit wherein the slurry is fed into a flotation circuit for recovering mineral concentrate and tailings. The mineral slurry is divided at least into two tailings flows having different means of particle sizes in a flotation cell system, that is arranged to receive the slurry from the grinding circuit and adapted to classify the slurry. The different tailings flows are fed for further flotation in banks of flotation cells arranged in parallel.

According to the invention at least two tailing flows are withdrawn via outlet openings arranged on different vertical levels of the classifying flotation cell of the flotation cell system.

In a grinding circuit, ore is grinded and slurry, that contains mineral particles, is produced for further processing in a flotation circuit. A typical solid content of such a slurry prepared for a flotation circuit is between 20 and 45%, in some special cases even lower or higher.

The classifying flotation cell system of the flotation circuit of the present invention is adapted to classify the slurry by particle size and pulp density. The flotation cell system may comprise several flotation cells arranged in series, but essential feature of the classifying cell system is that one of the cells in the system is capable of classifying the slurry into different slurry fractions and that the cell is provided with at least two outlet openings for withdrawing the different slurry fractions.

According to one preferred embodiment of the present invention, the classifying flotation cell system comprises one flotation cell that is a receiving cell that the slurry enters after the grinding circuit. The receiving cell has relatively high volume for the slurry. The pulp density on the bottom of the receiving cell is around the same as the density of the feed. The pulp density is gradually decreasing from the bottom of the cell to the pulp level. The pulp density may be around 10-20% on the top surface of the pulp. The classifying property of the receiving cell is realized with selecting suitable dimensions for the cell. The volume and the height of the cell are essential factors. The volume of the cell may range between 5 and even 5,000 m³, preferably between 5 and 500 m³ and most preferably between 5 and 380 m³.

The outlet openings of the receiving cell are arranged on different pulp levels of the cell. One of the outlet openings may be a conventional bottom outlet opening, when the outlet is arranged below or at the same level with the gas flotation mechanism of the cell.

According to another embodiment of the invention, in the flotation circuit, the flotation cell system comprises two flotation cells arranged in series and the downstream cell is capable of classifying the slurry and is provided with said outlet opening for withdrawing the slurry fraction and the upstream functions as a receiving cell.

These above mentioned objects are achieved by an apparatus and a method described later in the independent claims. Other advantageous embodiments of the invention are presented in the dependent claims. The apparatus and the method are suitable especially for metal and industrial minerals slurries. Furthermore, it may have advantages in special processes like oil and bitumen separation from sand or water.

### BRIEF DESCRIPTION OF THE DRAWINGS

The invention is described in more details referring to following drawings, where FIG. 1 is a schematic presentation of a flotation circuit of the present invention, and

FIG. 2 is a schematic cross-sectional side view of a receiving cell of one embodiment of the flotation circuit of the present invention.

### DETAILED DESCRIPTION OF THE INVENTION

Feed 11 of the flotation circuit of the present invention is produced in a grinding circuit, where ore is grinded for example in a SAG ball mill circuit. The particle size distribution of the in the slurry of the feed may be rather wide. The solid content of the feed 11 is typically between 20 and 45%. The feed enters the flotation circuit via a receiving cell 10. The receiving cell 10 is a flotation cell that comprises a flotation mechanism and froth launder system for recovering mineral rich froth. The receiving cell produces concentrate flow 25. Tailings 15, 16 of the receiving cell 10 are withdrawn via outlet openings arranged at different vertical position on the cell wall. The number of withdrawn tailings flows is at least two. In FIG. 1, the number or withdrawn tailings is drawn to be three but is not limited to that number. The tailings flows 15, 16 have different particle size distributions and different mean of particles sizes and/or different solid contents, since the receiving cell is arranged to classify the slurry into such fractions. The flotation circuit, as shown in FIG. 1, comprises also flotation cell banks 12, 13 which are adapted to float the particular type of tailings as received from the receiving cell 10. Each of the cell banks 12, 13 may comprise flotation cells arranged both in series and in parallel or they may comprise sub-banks of cells arranged in series or in parallel. The cell banks 12, 13 produce concentrate flows 18, 19 and tailings flows 22, 23.

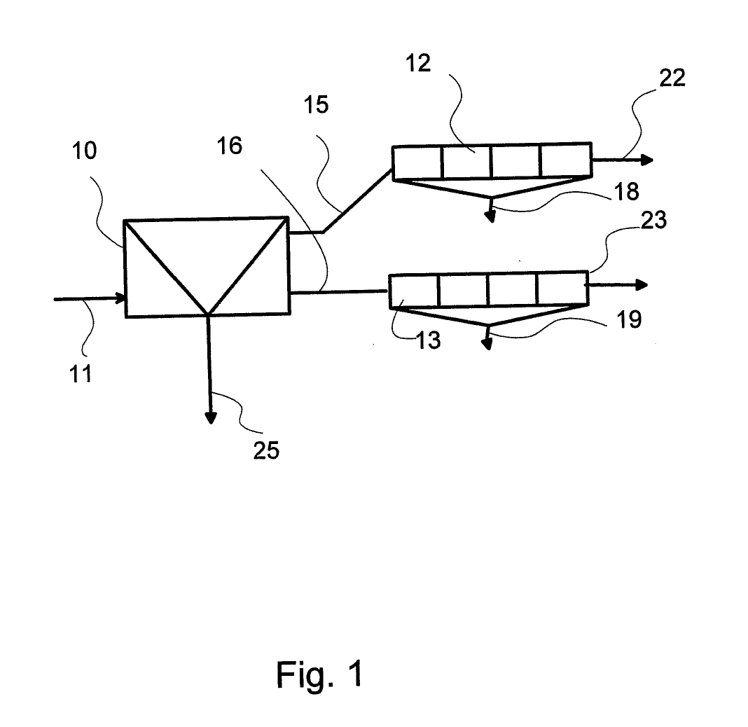

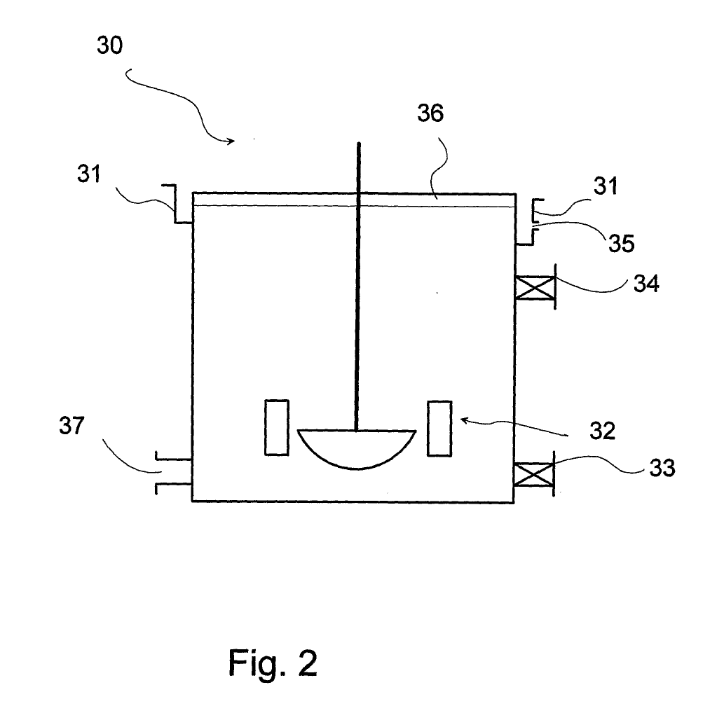

According to one preferred embodiment of the present invention the receiving cell comprises two outlet openings for withdrawing two different tailings flows. FIG. 2 shows a schematic side view presentation of a circular receiving cell 30, which is provided with flotation mechanism 32 with a rotor and a stator arranged around the rotor. Air is fed into the flotation mechanism via a hollow shaft arranged to rotate the rotor or via a gas inlet arranged below the mechanism. A froth layer 36 is depicted as well as a froth launder system 31 with one of more froth outlets 35. Outlet openings 33, 34 are arranged to feed two flows of tailings for further flotation in banks of flotation cells. A tailings flow with relatively coarser particle size distribution and higher solid contents is withdrawn via the bottom outlet opening 33. A tailings flow with finer particle size distribution and lower solid content is withdrawn via the side outlet opening 34, which is located essentially above the flotation mechanism. Feed from a grinding circuit is led into the receiving cell 30 via an inlet opening 37 arranged on the lower part of the cell. The volume of the receiving cell 30 is preferably between 160 and 500 m².

While the invention has been described with reference to its preferred embodiments, it is to be understood that modifications and variations will occur to those skilled in the art. Such modifications and variations are intended to fall within the scope of the appended claims.

1-10. (canceled)

11. A flotation circuit for separating mineral concentrates from mineral slurry, comprising flotation cell lines arranged in series or in parallel, wherein the flotation circuit comprises:
a flotation cell system, which is arranged to receive a feed of mineral containing slurry from a grinding circuit and comprises a flotation cell that is capable of classifying the slurry and that is provided with at least two outlet openings for discharging tailings with different particle size distributions and means of particle sizes, and
at least two parallel flotation cell lines each of them arranged to receive a flow of tailings from the output opening of the classifying flotation cell and adapted to process slurries with certain particle size distributions.

12. The flotation circuit according to claim 11, wherein the flotation cell system comprises two flotation cells arranged in series and the downstream cell is capable of classifying the slurry.

13. The flotation circuit according to claim 11, wherein the classifying cell comprises a first outlet opening and a second outlet opening arranged on different pulp levels of the cell.

14. The flotation circuit according to claim 13, wherein the first outlet opening is a bottom outlet opening arranged on the same level or below the flotation mechanism of the cell and the second outlet opening is arranged essentially above the flotation mechanism.

15. The flotation circuit according claim 11, wherein the classifying flotation cell system is comprised of one classifying flotation cell.

16. The flotation circuit according claim 11, wherein the volume of the classifying flotation cell of the classifying flotation cell system is between 5 and 5,000 m³, preferably between 5 and 500 m³ and most preferably between 5 and 380 m³.

17. The flotation circuit according to claim 11, wherein the solid content of the slurry received from a grinding circuit is between 20 and 45%.

18. A method of floating mineral slurry produced in a grinding circuit wherein the slurry is fed into a flotation circuit for recovering mineral concentrate and tailings, wherein the mineral slurry is divided at least into two tailings flows having different means of particle sizes in a flotation cell system that is arranged to receive the slurry from the grinding circuit and adapted to classify the slurry, and the different tailings flows are fed for further flotation in banks of flotation cells arranged in parallel.

19. The method of claim 18, wherein at least two tailing flows are withdrawn via outlet openings arranged on different vertical levels of the classifying flotation cell of the flotation cell system.

20. The method of claim 18, wherein the solid content of the slurry received from a grinding circuit is between 20 and 45%.
